(19) United States
(12) Patent Application Publication
(10) Pub. No.: US 2009/0167544 A1
(43) Pub. Date: Jul. 2, 2009

(54) Boost Voltage For Fire System Notification Appliance Circuits

(76) Inventors: Donald Edward Becker, Bradenton, FL (US); William Edwards, Bradenton, FL (US); Michael Goodheart, Bradenton, FL (US); Richard Tucker, Bradenton, FL (US)

Correspondence Address: General Electric Company;GE Global Patent Operation, PO Box 861, 2 Corporate Drive, Suite 648, Shelton, CT, 06484, US

(21) Appl. No.: 11/967,804

(22) Filed: Dec. 31, 2007

(51) Int. Cl. G08B 21/00

(52) U.S. Cl. 340/636.12

(57) ABSTRACT

An apparatus includes one or more notification circuits for powering devices for alerting personnel of certain conditions and a power supply path for the one or more notification circuits modeled according to a specification, and a battery backup power supply connected to the one or more notification circuits having circuitry that boosts an output voltage of the battery backup power supply such that the devices of the one or more notification circuits as modeled are provided with a working voltage and current. In addition, a method includes modeling one or more notification circuits for powering devices for alerting personnel of certain conditions and a power supply path for the one or more notification circuits according to a specification, and boosting the output of a battery backup power supply connected to the power supply path such that the devices are provided with at least a working voltage and current as modeled.

### BACKGROUND

1. Field of the Invention

The disclosed embodiments relate to systems with battery backup power supplies.

2. Description of Prior Art

Many systems include a battery backup power supply in order to maintain operations when a main power supply is faulty or interrupted. For example, a typical fire safety system generally includes a battery backup in order to maintain fire safety coverage when adequate AC mains power is not available. Other types of systems including life support and computer systems may also include self sufficient power supplies. Power supplied to circuits that power alerting devices in a typical fire safety system, also referred to as Notification Appliance Circuits (NACs), may be limited by the worst case voltage supplied by the fire system to the NACs and by the voltage drop across the NACs wiring. This may result in less than optimal coverage for such circuits.

For example, an NAC may be designed to have 30 devices, each drawing 100 milliamps and having a rated spacing of 10 feet at a working voltage and current. Thus, the NAC would provide notification coverage of 300 feet. However, under real world conditions, because of voltage drops from the supply through various system components, for example, a panel, circuit wiring etc., and the wiring of the NAC itself, the NAC may be limited to less devices and less coverage length because the working voltage and current for all the devices may not be provided over the entire NAC as originally designed.

It would be advantageous to provide a power system with a battery backup that maintains a minimum working voltage for each device on an NAC over the optimum length of the NAC as designed.

### SUMMARY

In one embodiment, an apparatus includes one or more notification circuits for powering devices for alerting personnel of certain conditions and a power supply path for the one or more notification circuits that have been modeled according to a specification, and a battery backup power supply connected to the one or more notification circuits having circuitry that boosts an output voltage of the battery backup power supply such that all the devices of the one or more notification circuits as modeled are provided with a working voltage and current.

In another embodiment, a method includes modeling one or more notification circuits for powering devices for alerting personnel of certain conditions and a power supply path for the one or more notification circuits according to a rated spacing, and boosting the output of a battery backup power supply connected to the power supply path such that all the devices are provided with at least a working voltage at their current requirements at the rated spacing.

### BRIEF DESCRIPTION OF THE DRAWINGS

The foregoing aspects and other features of the presently disclosed embodiments are explained in the following description, taken in connection with the accompanying drawings, wherein:

FIG. 1 shows a block diagram of a system suitable for practicing the disclosed embodiments;

FIG. 2 shows an exemplary power system for use with the disclosed embodiments;

FIG. 3 shows another exemplary power system for use with the disclosed embodiments; and

FIG. 4 shows a flow diagram of the operation of the disclosed embodiments.

### DETAILED DESCRIPTION

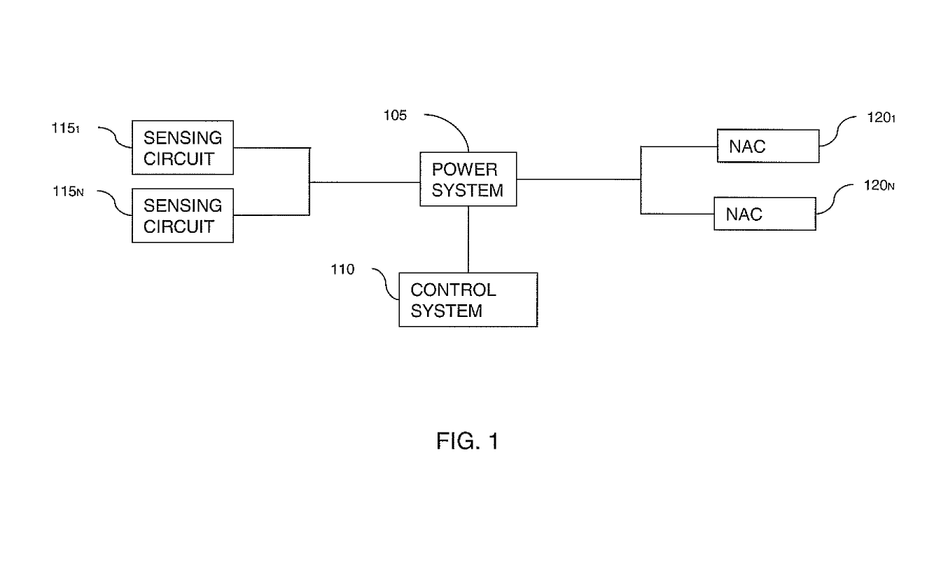

FIG. 1 shows a block diagram of an exemplary system 100 suitable for practicing the embodiments disclosed herein. Although the presently disclosed embodiments will be described with reference to the drawings, it should be understood that they may be embodied in many alternate forms. It should also be understood that in addition, any suitable size, shape or type of elements or materials could be used.

The disclosed embodiments are directed to modeling an NAC and its supply path according to a specification and boosting the voltage at a power supply output to ensure that all devices powered by the NAC are provided with a proper working voltage and current. The design specification for an NAC may include a current and voltage provided at a system panel output as prescribed by regulations to which the equipment may conform, or other parameters of an NAC.

Returning to FIG. 1, a typical fire safety system may include a power system 105, a control system 10, one or more sensing circuits 115₁ . . . 115ₙ and one or more NACs 120₁ . . . 120ₙ. The power system 105 may supply power to the control system 110, the one or more sensing circuits 115₁ . . . 115ₙ and the one or more NACs 120₁ . . . 120ₙ in any combination, or may supply power only to the one or more NACs 120₁ . . . 120ₙ. The control system may control the operations of the power system 105, the one or more sensing circuits 115₁ . . . 115ₙ and the one or more NACs 120₁ . . . 120ₙ. In other embodiments, the power system 105 may operate independently. The one or more NACs 120₁ . . . 120ₙ include one or more notification appliances, for example, strobes, horns, or other devices for alerting personnel that particular conditions may exist, such as but not limited to, fire, smoke, fumes, or other conditions.

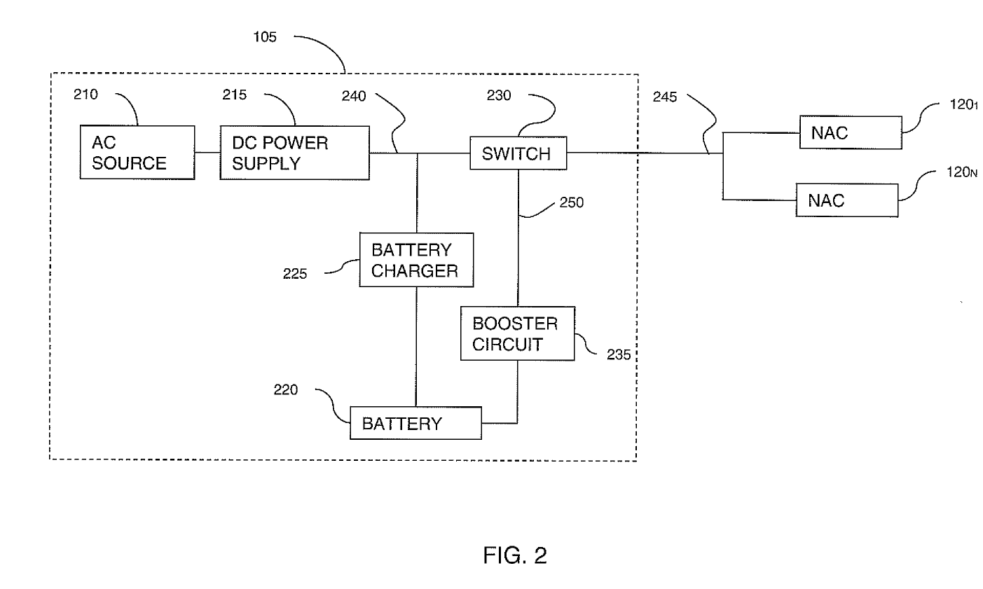

FIG. 2 shows the power system 105 in greater detail. Power system 105 may include an AC mains power source 210, a DC power supply 215, one or more batteries 220, a battery charger 225, a power switch 230 connected to the one or more NACs 120₁ . . . 120ₙ and a booster circuit 235. The AC mains power source 210 may include any readily available electrical power supply and is typically provided by a power utility company. The DC power supply 215 may accept a wide range of AC voltages and generally provides power suitable for at least driving the one or more NACs 120₁ . . . 120ₙ. The switch 230 generally operates to switch between the DC power supply 215 and the booster circuit 235. The switch 230 may include a sensing mechanism and if the DC power from the DC power supply 215 becomes unsuitable for the one or more NACs 120₁ . . . 120ₙ, the switch 230 may switch from the DC power supply 215 to the booster circuit 235. The switch 230 may also operate to restore power from the DC power supply 215 and isolate the booster circuit 235 if the DC power supply 215 again becomes suitable for use. The battery charger 225 may operate to charge the battery 220 to a voltage slightly above the nominal voltage 240 supplied by the DC power supply 215.

The booster circuit 235 provides a voltage at its output 250 that ensures that all devices powered by the one or more NACs 120₁ . . . 120ₙ as designed are provided with a proper working voltage and current. The working voltage and current for a particular device includes a range of voltage and current within which the device will operate according to its specifications. The output 250 of the booster circuit may be variable or fixed and is generally determined by modeling the power supply path to the one or more NACs 120₁ . . . 120ₙ and the one or more NACs 120₁ . . . 120ₙ themselves including the characteristics of the attached devices and wiring. The power supply path to the one or more NACs 120₁ . . . 120ₙ may include the connection 250 from the booster circuit 235 to the switch 230 and the path 245 to the one or more NACs 120₁ . . . 120ₙ including any panel or terminal connections. For example, by analyzing the working current and voltage for each of the notification appliances attached to a particular NAC 120 as designed, the impedance provided by the wiring of the NAC, the voltage drop of power switch 230, and the parameters of any other components of the power supply path, a minimum voltage that must be provided at the output 250 of the booster circuit 235 may be determined. Once determined, the output 250 of the booster circuit 235 may be adjusted to provide a voltage that ensures that all devices powered by the one or more NACs 120₁ . . . 120ₙ are provided with a proper working voltage and current. In at least one embodiment, the booster circuit 235 includes a switching voltage regulator in a boost configuration.

Using the example above, an NAC may be designed to have 30 devices, each drawing 100 milliamps and having a rated spacing of 10 feet at a working voltage and current, in order to provide notification coverage of 300 feet. Utilizing the working current and voltage for each of the notification appliances attached to the NAC, the impedance provided by the wiring of the NAC, the voltage drop of power switch 230, and the parameters of any other components of the power supply path, a minimum voltage that must be provided at the output 250 of the booster circuit 235 may be calculated and the output 250 of the booster circuit 235 may be adjusted to provide a voltage that ensures that all of the 30 devices are provided with a proper working voltage and current under all conditions.

It should be noted that a current and voltage provided at path 245 may referred to as a panel output and may be specified by regulations governing the system 100.

In at least one embodiment, the booster circuit 235 may have no effect so long as the battery output is above a certain threshold. For example, if the nominal battery voltage provides the minimum voltage at the input 245 to the one or more NACs 120₁ . . . 120ₙ that ensures that all devices powered by the one or more NACs 120₁ . . . 120ₙ are provided with a proper working voltage and current, then the booster circuit 235 may be adjusted or set to have no effect unless the battery voltage falls below the nominal battery voltage. As another non-limiting example, if a battery voltage of approximately 22.5 volts provides a proper working voltage and current at the input 245 then the booster circuit 235 may be set to have no effect unless the battery voltage falls below 22.5 volts. Setting the booster circuit 235 in this manner may ensure that power derived from the battery 220 when required is delivered at peek efficiency.

In at least one other embodiment, the boost circuit 235 may be set so that in combination with the DC power supply 215, a voltage of between 22.5 volts and 24 volts may be provided to the one or more NACs 120₁ . . . 120ₙ under all conditions.

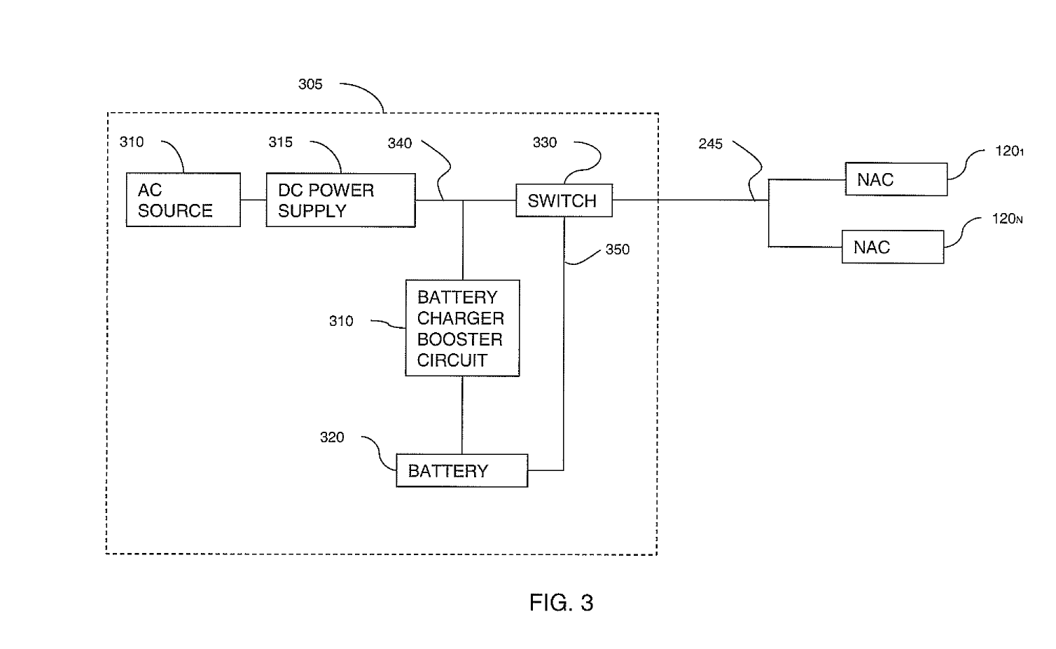

FIG. 3 shows another embodiment of a power system 305. Power system 305 may include an AC mains power source 310, a DC power supply 315, one or more batteries 320, and a power switch 330 connected to the one or more NACs 120₁ . . . 120ₙ similar to power system 105, In this embodiment, the battery charger and booster circuit may be incorporated together as a single unit 310. The battery charger booster circuit 310 may operate to charge the battery to a voltage such that battery output 350 provides the required voltage that ensures that all devices powered by the one or more NACs 120₁ . . . 120ₙ are provided with a proper working voltage and current.

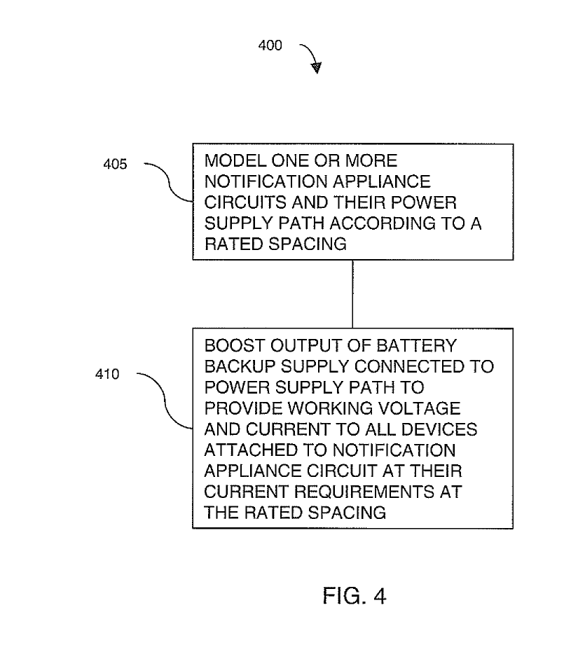

FIG. 4 shows a flow diagram of the disclosed embodiments as described herein. In block 405, the one or more notification circuits for powering the alerting devices are modeled along with their power supply path according to a rated spacing of the devices. In block 410, the output of a battery backup power supply connected to the power supply path is boosted such that all the devices are provided with at least a working voltage at their current requirements at the rated spacing.

Thus, the disclosed embodiments provide for more efficient use of the one or more NACs 120₁ . . . 120ₙ allowing them to utilize their fully rated power, and to allow for a maximum coverage area of the attached notification devices. Equipment and installation costs may be reduced as compared to other systems that rely solely on power systems without the booster circuitry 235, 310.

It should be understood that the foregoing description is only illustrative of the present embodiments. Various alternatives and modifications can be devised by those skilled in the art without departing from the embodiments disclosed herein. Accordingly, the embodiments are intended to embrace all such alternatives, modifications and variances which fall within the scope of the appended claims.

What is claimed is:

1. An apparatus, comprising:
one or more notification circuits for powering devices for alerting personnel of certain conditions and a power supply path for the one or more notification circuits that have been modeled according to a specification; and
a battery backup power supply connected to the one or more notification circuits having circuitry that boosts an output voltage of the battery backup power supply such that all the devices of the one or more notification circuits as modeled are provided with a working voltage and current.

2. The apparatus of claim 1, further comprising a fire safety system.

3. The apparatus of claim 1, wherein the specification includes a specified voltage and current at a panel output supplying the one or more notification circuits.

4. The apparatus of claim 1, wherein the specification includes a working voltage and current of each of the devices.

5. The apparatus of claim 1, wherein the specification includes a wiring impedance of the one or more notification circuits.

6. The apparatus of claim 1, wherein the circuitry that boosts an output voltage of the battery backup power supply further comprises a switching regulator connected between an output of a battery of the battery backup power supply and the power supply path.

7. The apparatus of claim 1, further comprising a battery charging circuit that includes the circuitry that boosts an output voltage.

8. A method, comprising:
modeling one or more notification circuits for powering devices for alerting personnel of certain conditions and a power supply path for the one or more notification circuits according to a rated spacing; and
boosting the output of a battery backup power supply connected to the power supply path such that all the devices are provided with at least a working voltage at their current requirements at the rated spacing.

9. The method of claim 8, wherein the notification circuits comprise a fire safety system.

10. The method of claim 8, wherein the specification includes a specified voltage and current at a panel output supplying the one or more notification circuits.

11. The method of claim 8, wherein modeling the one or more notification circuits includes analyzing a working voltage and current of each of the devices.

12. The method of claim 8, wherein modeling the one or more notification circuits includes analyzing a wiring impedance of the one or more notification circuits.

13. The method of claim 8, wherein boosting the output of the battery backup power supply includes utilizing a switching regulator connected between an output of a battery of the battery backup power supply and the power supply path.

14. The method of claim 8, wherein boosting the output of the battery backup power supply includes charging a battery of the battery backup power supply to a voltage such that all the devices are provided with at the at least a working voltage at their current requirements at the rated spacing.
